(19) United States
(12) Patent Application Publication
(10) Pub. No.: US 2010/0075163 A1
(43) Pub. Date: Mar. 25, 2010

(54) Metal preservative coating composition and method

(76) Inventor: Dhrubo Bhattacharya, New Delhi (IN)

Correspondence Address: JACOBSON HOLMAN PLLC, 400 SEVENTH STREET N.W., SUITE 600, WASHINGTON, DC, 20004, US

(21) Appl. No.: 12/448,777

(22) PCT Filed: Dec. 24, 2007
(86) PCT No.: PCT/IB2007/004179

§ 371 Date: Jul. 7, 2009

(30) Foreign Application Priority Data
Jan. 8, 2007 (IN) 25/KOL/2007

(51) Int. Cl. B32B 15/082; B05D 3/00; B32B 15/18; C09D 129/04

(52) U.S. Cl. 428/461; 427/327; 524/557

(57) ABSTRACT

An invention discloses an ambient or online heat curing chromate free, corrosion resistant coating composition comprising (a) a linear vinyl terpolymer having three randomly distributed functional groups comprising acetyl, formal and hydroxy! groups along the vinyl backbone that offers cross-linking sites through the hydroxyl groups during cure; (b) one or more alkoxy amino resin(s); (c) a mineral acid catalyst; (d) a blend of organic solvents and optionally (e) one or more chromate free inorganic pigment and/or organic dyes.

### FIELD OF THE INVENTION

The invention is in the field of chromate free ambient or on-line curing metal preservative coating composition, particularly suitable for coating mill scale covered hot rolled steel, galvanized steel and metalized steel as these products roll out from the steel mills and to coating method using such composition. The coating thus applied protects the metal products from corrosion and rusting during storage and transit.

This invention relates to a thin film ambient curing chromate free coating composition based on a polymeric material, particularly a vinyl terpolymer of polyvinyl formal, polyvinyl alcohol and polyvinyl acetate, and an alkoxy-amino resin cross-linker, particularly a butylated urea formaldehyde resin. This coating composition can be applied on ferrous or non-ferrous metallic substrates.

### BACKGROUND OF THE INVENTION

Hot rolled steel structures are protected from environmental corrosion by means of variety of conventional and high performance paints that are applied after fabrication of such structures. Mill scale formed on the surface of hot rolled steel during its manufacture is inherently protective in nature being cathodic to steel. However, it rapidly converts to rust during exposure to humidity in the environment. Rust removal by mechanical or chemical methods becomes imperative prior to paint application. Further, even non-rusted hot rolled steel with mill scale, cannot be effectively protected by paint systems available. Hence, hot rolled steel is routinely blasted as an essential prelude to paint application. This process is often followed by application of wash/shop primers to enhance corrosion protection and adhesion of topcoats. While new structures may be sand/grit blasted, old existing structures may not always be amenable to such techniques. Blasting necessarily leads to loss of metal, is environmentally polluting, and blasted steel has to be protected with primers/paints almost immediately after, else corrosion sets in quickly. Moreover, blasting is rarely able to provide a completely uniform and clean surface free of contaminants.

In-plant coating of hot rolled steel as manufactured, with an inhibitive system, would therefore provide an ideal way to prevent surface contamination and rust formation in high humidity field environments. This practice would also ensure a reproducible surface, however such a coating must necessarily have the abrasion resistance and adhesion to maintain its integrity during the transportation and handling of pre-coated articles.

Chromate free wash primers are well known, for example as disclosed in U.S. Pat. Nos. 5,077,332, 5,891,960, 6,084,036 and 6,169,150. These are principally used on galvanized steel and mostly use polyvinyl butyral resin. Similarly shop primers, for example as disclosed in U.S. Pat. Nos. 4,888,056 and 6,468,336, are extensively used on blasted hot rolled steel. Wash and shop primers provide temporary protection to coated substrates and are useful tie coats for further painting. However no composition is available for use on non blasted mill scale covered steel. Further, although metal products coated with wash/shop primers are weldable, these may not have the required degree of abrasion resistance to permit handling and transportation of pre-coated steel products, if such coating is applied in steel mills.

The inventor of the instant invention has found that a tough thin film transparent coating based on a vinyl terpolymer cross linked with an alkoxy amino resin forms a tightly adherent abrasion resistant coat on mill scale covered hot rolled steel as well as galvanized steel and provides excellent barrier characteristics to retard the ingress of moisture and air to the steel surface. The thin film integrates itself with the mill scale of hot rolled steel, occupying the voids and discontinuities in it, and cannot be removed from the coated surface except by strong mechanical attrition. It also provides a surface of good lubricity and has excellent flexibility and aesthetic appeal. Such a coated article will withstand normal environmental attack on extended storage and limited exposure to hostile environs such as transit in high seas when steel is shipped overseas. Hence the coating may be useful in providing a rust free substrate to users if it is applied over hot rolled steel products both flat as well as tubular, as manufactured in steel mills, prior to dispatch, preferably with online heating, where coated substrates may reach a temperature of about 80° C. to 90° C., to facilitate drying. Such pre-coated hot rolled steel may also be welded upon and can be effectively protected from long term corrosion, by applying conventional or high performance paints, directly on the pre-coated substrate. In other words, the preservative vinyl coating need not be stripped prior to paint application and acts as an excellent tie coat. This thin film coating provides a rust and contaminant free substrate for painting and therefore may eliminate the practice of blasting steel altogether. Further, by top coating with chromate free protective paints the entire coating system becomes chromate free. The coating prevents formation of white rust during transportation and storage of galvanized steel and also protects metallized steel.

The wet coating is formulated using a linear vinyl terpolymer containing randomly appended formal, acetyl and hydroxyl groups, an alkoxy amino resin cross-linker such as a partially isobutylated urea formaldehyde resin for curing at ambient temperature, and a mineral acid such as phosphoric acid. It has excellent adhesion to variety of un-oiled/de-oiled metallic substrates such as hot rolled and cold rolled steel, galvanized and aluminized steel, apart from exceptional impact strength and scratch hardness, good corrosion, chemical, and thermal resistance in thin films with dry film thickness (DFT) ranging from 5 to 25 micrometers. On galvanized substrates it restricts the formation of white rust. It is also compatible with a variety of topcoats both ambient curing as well as stoving. It will be obvious to someone skilled in the art that such properties offer a viable method of rust/corrosion protection of hot rolled steel and white rust prevention of galvanized steel, from the time of manufacture.

In an embodiment of the invention such coating composition satisfying the need of quick curing in an online in-plant condition with oven heating is ensured by proper choice of alkoxy amino resin cross-linker.

Outstanding adhesion to mill scale covered hot rolled steel, galvanized and metallized steel, coupled with high flexibility and hardness, resistance to impact, wear, abrasion, chemicals and corrosion, makes the coating composition of the present invention ideally suitable for preservation of such products when exposed to vagaries of climatic conditions during transit and storage.

### OBJECTS OF THE INVENTION

The first object of the invention is to provide a quick ambient or in-plant online curing thin film polymer coating composition that is suitable for rust protection of mill scale covered hot rolled steel and cold rolled steel, and white rust protection of galvanized steel.

The second object of the invention is to provide a polymer coating, which has a high degree of impact strength, flexibility and surface hardness so that coated products may easily be handled during transportation.

The third object of the invention is to provide an environment friendly chromate free corrosion resistant coating composition that may be applied online on steel products, both flat and tubular, without blasting or chemical pre-treatment.

Another object of the invention is to provide a method for coating a ferrous substrate with a corrosion resistant composition to eliminate blasting of steel altogether by offering pre-coated rust and contaminant free steel substrate.

Yet another object of the invention is to provide coated articles with its surface coated by applying the coating composition according the invention.

### SUMMARY OF THE INVENTION

Accordingly the present invention provides a thin film, ambient or on line heat curing, chromate free, corrosion resistant coating composition comprising:

a) a linear vinyl terpolymer having three randomly distributed functional groups comprising acetyl, formal and hydroxyl groups along the vinyl backbone that offers cross-linking sites through the hydroxyl groups during cure;

b) one or more alkoxy amino resin(s);

c) a mineral acid catalyst;

d) a blend of organic solvents and optionally,

e) one or more chromate free inorganic and/or organic pigment.

The said alkoxy amino resin is preferably a medium molecular weight partially isobutylated urea formaldehyde resin.

In the alternative embodiment, a suitable alkoxy amino resin may also be used to further increase the cross linking if desired, when on line heating is possible.

The said mineral acid is preferably ortho-phosphoric acid.

The said vinyl terpolymer has 6-15% polyvinyl alcohol content, 9-15% polyvinyl acetate content, and 70-84% polyvinyl formal content, by weight.

The organic solvent blend preferably is a mix of ortho-xylene and n-butanol in the weight ratio of 60:40.

The coating composition may be suitably pigmented with inorganic and/or organic pigment/dye to obtain pigmented coatings in a choice of attractive colors with medium to high gloss.

The invention also provides a method of coating ferrous or non-ferrous metal substrates by applying the composition according to invention on the surface of the said substrate in desired thickness and curing the same.

The invention further provides a coated article comprising a ferrous substrate coated with the composition according to the invention.

### DETAILED DESCRIPTION OF THE INVENTION

In the composition of the present invention a linear vinyl terpolymer, with three functional groups namely, acetyl, formal and hydroxyl groups randomly distributed along the vinyl backbone, offers cross-linking sites through the hydroxyl groups. The density of cross-links iii the cured matrix may be controlled by the number and placement of hydroxyl groups on the vinyl backbone of polymer. This polymer possesses a rare combination of mechanical, thermal, chemical and dielectric properties. The functional groups along with its vinyl backbone confer to this Polymer the properties of adhesion, toughness, chemical inertness and heat stability while the long linear chains contribute to the outstanding flexibility. The spatial structure of this thermoplastic material helps to form a closely packed molecular structure, which provides excellent barrier characteristics when coated on a wide array of substrates. The hydroxyl groups are fully accessible for cross-linking and this makes the thermoplastic polymer, heat curable in the presence of a mineral acid. The chain length distribution of a poly disperse polymer is made such as to permit film formation, migration by diffusion to the substrate and development of the required cohesive strength in the coating. Specifically, the terpolymer used in the invention has weight average molecular weight ranging between 15,000 and 80,000 preferably between 20,000 and 50,000. The content of polyvinyl alcohol, polyvinyl acetate and polyvinyl formal of the vinyl terpolymer used for the invention is 6-15%, 9-15% and 70-84% respectively by weight and preferably 6.0-7.5%, 10-13% and 80-83% respectively by weight.

The said terpolymer useable in the composition may be produced by simultaneous hydrolysis and formalization of polyvinyl acetate in acetic acid media. For this purpose polyvinyl acetate of the required weight average molecular weight (28,000-140,000) and of low to very low branching frequency is dissolved in acetic acid and formalin (37% formaldehyde aqueous solution) at room temperature. Dilute sulfuric acid (N/10 normality) is added to this solution with agitation. The contents are well stirred, heated to 75° C. and maintained at this condition for 20-24 hours. The whole process is conducted in a homogenous solution state. By regulating quantities of acetic acid, water and formaldehyde, the required composition of the functional groups of the vinyl backbone viz. acetyl, hydroxyl and formal may be obtained. Typically for one part of polyvinyl acetate, 1.65 parts of acetic acid, 0.55 part of water and 0.45 part of formalin (37% formaldehyde solution in water) is used to obtain a composition comprising 6.0-6.5% polyvinyl alcohol, 11.0-12.0% polyvinyl acetate and 81.5-83.0% polyvinyl formal. The extent of reaction is determined by the percentage of hydroxyl and acetyl groups in the extracted polymer and the reaction is terminated at the desired point by neutralizing the acid catalyst with a dilute alkali. The polymer is next precipitated from solution by adding water as non-solvent, washed and dried to 98-99% solids. The simultaneous hydrolysis and formalization reactions in a homogenous media prevent the development of blocky sequences on vinyl chain and thus helps to get a random terpolymer. The T_{g} of the terpolymer so produced ranges from 100° C.-115° C.

The alkoxy amino resin used as cross-linker for ambient curing is a medium molecular weight urea formaldehyde resin, which is partially alkylated. Specifically CYMEL U-662 of Cytec Industries has been used in the examples. It is partially isobutylated and has a medium degree of alkylation, a medium methylol content and a low imino functionally. The product has 60% solids, contains xylene and isobutanol as solvents, and has viscosity of 1200-2400 mPa.s of 23° C.

For, an online coating composition curable at about 80° C. to 90° C., through oven heating, other alkoxoxy amine resin cross linkers like methylated melamine formaldehyde, CYMEL 303, may additionally be used.

The coating is a two-component system comprising the vinyl terpolymer, in solution with the catalyst, as component A, and the amino resin solution as the component B. Pigment when used is also a part of component A. The two components may be mixed while stirring and used within 2-4 hours. The preferred proportion of the alkoxy urea formaldehyde amino resin is 10-20% of the vinyl, terpolymer by weight, more preferably 14-17% by weight, and that of the acid is 4-14% of the polymer by weight, more preferably 10-12% by weight when ortho phosphoric acid is used. If pigment is to be added a mill base is first prepared in the polymer solution. For this purpose, a concentrated solution of the polymer in the solvent blend is used and the dry pigment is added and milled in an attritor/ball mill for approximately 6-8 hours. Component B also contains the same solvent blend. The final weight solids is adjusted by adding the requisite amount of solvent blend to provide preferably 6-18% overall weight solids depending on the mode of application.

Components of the solvent blend may be selected from aliphatic alcohols such as methanol, ethanol, isobutanol, isopropanol, n-butanol and aromatics such as toluene, xylene. Other solvents such as butyl cellosolve and its acetate, and solvent naphtha may also be used as co-solvents/diluents. Preferably the solvent blend comprises ortho xylene and n-butanol in a 60/40 ratio by weight.

Phosphoric acid, para toluene sulfonic acid may be used as the acid catalyst for this formulation. However best properties are obtained with ortho phosphoric acid. This ambient curable clear coat system may be pigmented to impart color with medium to high gloss.

The coating can be formulated both as transparent clear as well as pigmented opaque coating in volatile organic solvents and may be spray or flow coated on metal substrates.

The coating composition of the instant invention may be applied to metal substrates including hot rolled steel, cold rolled steel, hot dip galvanized steel, aluminized steel in thin films of DFT ranging from 5-25 micrometers, preferably 5-15 micrometers by means of spray or flow coating methods. The two-component system can be stored at room temperature for minimum one year. Should storage temperature fall below 25° C. component A may have to be warmed to 30° C. and stirred well prior to use.

The following examples of compositions are illustrative of the invention and are not intended to limit the scope of the invention as defined by the appended claims.

The polyvinyl terpolymer as used in these examples is prepared by the process as described earlier with the weight content of polyvinyl alcohol, polyvinyl acetate and polyvinyl formal at 6.0-7.5%, 10-13% and 80-83% respectively and a weight average molecular weight between 25,000 and 30,000.

### EXAMPLE 1

### Clear Coat

A clear coat composition may be prepared from the listed ingredients in the following range of weight ratios:

| | |
|---|---|
| INGREDIENTS | % BY WEIGHT |

COMPONENT A

| | |
|---|---|
| Polyvinyl Terpolymer | 6-8 |
| o-Phosphoric Acid (88-93%) | 0.24-1.12 |
| o-Xylene | 41-56 |
| n-Butanol | 28-37 |

COMPONENT B

| | |
|---|---|
| CYMEL U-662 | 0.6-1.6 |
| o-Xylene | 3.6-6 |
| n-Butanol | 2.4-4 |

The clear coating is obtained by mixing the two components together.

A specific clear coat composition containing the following ingredients in the indicated weight percentage was prepared by mixing the two components A and B.

TABLE 1

| INGREDIENTS | % BY WEIGHT |
|---|---|
| Polyvinyl Terpolymer | 6.9 |
| CYMEL U-662 | 1.83 |
| o-Xylene | 54.26 |
| n-Butanol | 36.18 |
| o-Phosphoric Acid (88-93%) | 0.83 |

### EXAMPLE 2

### Pigmented/Dyed Coat

Colors can be incorporated by adding inorganic or organic pigments/dyes in a proportion upto 40% by weight of the total polymer and resin content in solvent bearing compositions.

A pigmented/dyed coating composition of the invention may be prepared from the following ingredients with weight percentage as indicated:

| INGREDIENTS | % BY WEIGHT |
|---|---|
| Polyvinyl terpolymer | 6.32 |
| CYMELU-662 | 1.69 |
| Fire red organic dye | 0.21 |
| o-Xylene | 54.57 |
| n-Butanol | 36.38 |
| Ortho Phosphoric Acid (88-93%) | 0.83 |

### EXAMPLE 3

### On Line Coat

An online coating composition, curable at 80-90° C. may be prepared from the following ingredients that includes a methylated melamine formaldehyde resin e.g. Cymel 303 with weight percentage as indicated:

| INGREDIENTS | % BY WEIGHT |
|---|---|
| Polyvinyl Terpolymer | 6.85 |
| CYMELU-662 | 1.82 |
| CYMEL 303 | 0.69 |
| o-Xylene | 53.89 |
| n-Butanol | 35.93 |
| Ortho Phosphoric Acid (88-93%) | 0.82 |

The non-volatile components of the coating composition of this invention including the polymer, butylated urea formaldehyde resin and pigments can range from 6-18% and is typically between 8-15% by weight of the total composition.

Black hot rolled steel(HRS), fresh cold rolled steel(CRS), and hot dip galvanized steel(HDG) panels were used immediately after rinsing with xylene to remove oil and grease. The composition of TABLE 1 was applied by brush on HRS, CRS and HDG panels. When air dried at 25° C., tack free condition is achieved in one hour and hard dry condition in 4 hours for DFT of 25 micrometers. For testing purposes the coated panels were force cured at 70° C. for two hours. All panels passed water immersion test for 24 hours and showed excellent compatibility with stoving paints such as alkyds and air drying paints such as polyurethane. All such top coated panels passed adhesion tests as per ASTM D3359. Results of other tests conducted on coated panels are summarized in the following table:

| Panel type | CRS | HDG | HRS |
|---|---|---|---|
| Cross hatch | 5B | 5B | 5B |
| adhesion | | | |
| Flexibility | Passes, no visual | Passes, no visual | — |
| | cracking or | cracking or | |
| | disbondment | disbondment | |
| Pencil hardness | 4H | 4H | 4H |
| Impact resistance | 100 lb · in | 100 lb · in | — |
| (Direct) | | | |
| Solvent resistance | 50+ | 50+ | 50+ |
| Chemical | Passes | Passes | Passes |
| resistance HCL, | | | |
| H₂SO₄, NAOH | | | |
| Corrosion | 25μ - 400 hrs. | 25μ - 500 hrs. | 10μ - 120 hrs. |
| resistance | No red rust | no white rust | No red rust |
| | | 5μ-200 hrs. | 20μ - 200 hrs. |
| | | no white rust | No red rust |

Testing Method

Ten tests were carried out on each of the substrate and the average value has been quoted in above table. The testing methods that were followed are given below:

i) Adhesion—Permacell brand tape was used as per ASTM D 3359, METHOD B.

ii) Flexibility—CRS and HDG coated substrate was bent on a mandrel of ⅛ inch diameter and observed for any cracking visually. Next, Permacell tape was applied at the bend. and coating pick off on the tape was observed on its removal.

iii) Pencil Hardness—Mitsubishi Uni pencils were used, and the test was conducted as per ASTM D 3363.

iv) Impact Resistance: Direct impact test was done as per ASTM D 2794.

v) Solvent resistance—A cloth soaked with methyl ethyl ketone was used to rub over coated surface for the prescribed number of times as per ASTM D 740 and reported as double rubs.

vi) Chemical resistance—Resistance to chemicals was tested as per ASTM D 1308 as modified in ASTM D3730.

vii) Resistance to neutral salt fog (corrosion resistance): This test was done as per ASTM B 117.

1. An ambient or online heat curing chromate free, corrosion resistant coating composition comprising:
a) a linear vinyl terpolymer having three randomly distributed functional groups comprising acetyl, formal and hydroxyl groups along the vinyl backbone that offers cross-linking sites through the hydroxyl groups during cure;
b) one or more alkoxy amino resin(s);
c) a mineral acid catalyst;
d) a blend of organic solvents and optionally
e) one or more chromate free inorganic pigment and/or organic dyes

2. The coating composition as claimed in claim 1 wherein the percentages by weight of polyvinyl alcohol, polyvinyl acetate and polyvinyl formal of the vinyl terpolymer are 6.0-15%, 9-15% and 70-84% respectively.

3. The coating composition as claimed in claim 2 wherein the percentages by weight of polyvinyl alcohol, polyvinyl acetate and polyvinyl formal of the vinyl terpolymer are 6.0-7.5%, 10-13% and 80-83% respectively.

4. The coating composition as claimed in claim 1, wherein the weight average molecular weight of said vinyl terpolymer is 15,000 to 80,000.

5. The coating composition as claimed in claim 4 wherein weight average molecular weight of said vinyl terpolymer is 20,000 to 50,000.

6. The coating composition as claimed in claim 1 wherein the alkoxy amino resin used is a partially isobutylated urea formaldehyde resin for ambient curing.

7. The coating composition as claimed in claim 1, wherein the alokxy amino resin used are isobutylated urea formaldeyde and methylated melamine formaldeyde for online in-plant heat curing.

8. The coating composition as claimed in claim 7, wherein the partially isobutylated urea formaldehyde resin used is CYMEL U-662 and has medium degree of alkylation, medium methylol content, low imino functionality and a medium molecular weight, with a viscosity of 1200-2400 mPa.s at 23° C., and the methylated melamine formaldehye resin is CYMEL 303.

9. The coating composition as claimed in claim 1 wherein the components of the solvent blend are selected from xylene, toluene, naphtha, isopropanol, n-butanol, isobutanol, ethanol, methanol, butyl cellosolve, and butyl cellosolve acetate.

10. The coating composition as claimed in claim 9, wherein 60 parts of o-xylene and 40 parts of n- butanol by weight are used in the solvent blend.

11. The coating composition as claimed in claim 1 wherein 4-14% by weight of phosphoric acid based on the total weight of the vinyl terpolymer is used as the catalyst.

12. The coating composition as claimed in claim 1 which includes 0-40% of the polymer and resin content of one or more chromate free inorganic pigment and/or organic dye.

13. The coating composition as claimed in claim 1 wherein the ingredients are present in the following range of weight percentage in separate packages for components A and B:

| | |
|---|---|
| INGREDIENTS | % BY WEIGHT |

COMPONENT A

| | |
|---|---|
| PolyvinylTerpolymer | 6-8 |
| o-Phosphoric Acid (88-93%) | 0.24-1.12 |
| o-Xylene | 41-56 |
| n-Butanol | 28-37 |

COMPONENT B

| | |
|---|---|
| CYMEL U-662 | 0.6-1.6 |
| o-Xylene | 3.6-6 |
| n-Butanol | 2.4-4 |

14. The coating composition as claimed in claim 13 wherein upon mixing components A and B before application, the ingredients are present in the following percentage by weight:

| INGREDIENTS | % BY WEIGHT |
|---|---|
| Polyvinyl Terpolymer | 6.9 |
| CYMELU-662 | 1.83 |
| o-Xylene | 54.26 |
| n-Butanol | 36.18 |
| Ortho Phosphoric Acid (88-93%) | 0.83 |

15. The pigmented coating composition as claimed in claim 1, wherein the ingredients are present in the following percentage by weight:

| | |
|---|---|
| Polyvinyl Terpolymer | 6.32 |
| CYMEL U-662 | 1.69 |
| Fire Red Organic Dye | 0.21 |
| o-Xylene | 54.57 |
| n-Butanol | 36.38 |
| o-Phosphoric Acid (88-93%) | 0.83 |

16. A method of forming a coating on a ferrous or non-ferrous metallic substrate which comprises:
degreasing the surface of said substrate on which coating is to be applied, preferably by a volatile organic solvent such as xylene;
preparing the coating composition as defined in claim 1 by dissolving the vinyl terpolymer in the solvent blend and adding the catalyst to prepare component A, dissolving the alkoxy amino resin(s) in solvent blend to make component B, and finally, mixing the two components together;
applying said coating composition by spray coating or flow coating method on un-oiled/de- oiled HRS, CRS, HDG to attain the desired thickness;
curing coating either at ambient conditions or with mild heat at 80° to 90° C. to accelerate the drying process in on line, in plant conditions.

17. The method as claimed in claim 16, wherein the alkoxy amino resin used is partially isobutylated urea formaldehyde resin for ambient curing.

18. The method as claimed in claim 16, wherein the alkoxy amino resins used are isobutylated urea formaldehyde and methylated melamine formaldehyde for online in-plant heat curing.

19. The method as claimed in claim 16, wherein the DFT of the coating as applied is 5-25 micrometers.

20. The method as claimed in claim 19 where the DFT of the applied coating is 5-15 micrometers.

21. The method as claimed in claim 16, wherein the said coating is applied to the bare un-oiled/de-oiled substrate as a rust preventive coating during transit and extended storage.

22. The method as claimed in claim 15, wherein the said coating is used as tie coat for further application of an air drying paint or a heat curable stoving paint.

23. An article comprising:
a) a ferrous substrate
b) a coating applied to surface of the said substrate by a method as claimed in claim 16.

24. The article as claimed in claim 23, wherein the said substrate is selected from the group comprising of CRS, HDG, HRS.

25. The coating composition as claimed in claim 7, wherein the ingredients are present in the following percentage by weight:

| Ingredients | % by weight |
|---|---|
| Polyvinyl Terpolymer | 6.85 |
| CYMEL U-662 | 1.82 |
| CYMEL 303 | 0.69 |
| o-Xylene | 53.89 |
| n-Butanol | 35.93 |
| Ortho Phosphoric Acid (88-93%) | 0.82 |
